(19) United States
(12) Patent Application Publication
(10) Pub. No.: US 2024/0007609 A1
(43) Pub. Date: Jan. 4, 2024

(54) THREE DIMENSIONAL TELEVISION ATTACHMENT DEVICE

(71) Applicant: Pamela Metoyer, Lantana, FL (US)

(72) Inventor: Pamela Metoyer, Lantana, FL (US)

(21) Appl. No.: 17/853,878

(22) Filed: Jun. 29, 2022

(51) Int. Cl. H04N 13/302; H04N 5/645; H04N 13/398

(52) U.S. Cl. CPC H04N 13/302; H04N 5/645; H04N 13/398

(57) ABSTRACT

A three dimensional television attachment device for emitting three dimensional visuals includes a screen abutting a display of a television. The screen has a liquid crystal display for use in a shutter lens technology. The shutter lens technology exhibits three dimensional visuals from the display of the television. The screen has a top edge and a bottom edge. A pair of top clips is positioned on the top edge of the screen and each of the top clips secures to the upper edge of the television. A pair of bottom clips is positioned on the bottom edge of the screen. A pair of inputs is positioned on a right edge of the screen. A first input of the pair of inputs is holds a first insert of a connection cord, where the connection cord communicates the visuals from the display of the television to the screen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to television display attachment device and more particularly pertains to a new television display attachment device for emitting three dimensional visuals.

### (2) Description of Related Art Including Information Disclosed Under 37 CFR 1.97 and 1.98

The prior art relates to television display attachment devices. The prior art relates to a variety of television display attachment devices configured for being positioned upon a television display to enhance the visuals of the display. Known prior art lacks a television display attachment device configured attaching to a television display and emitting three dimensional visuals by the use of liquid crystal display.

### BRIEF SUMMARY OF THE INVENTION

An embodiment of the disclosure meets the needs presented above by generally comprising a screen being configured for abutting a display of a television. The screen has a liquid crystal display being configured for use in a shutter lens technology. The shutter lens technology is configured for exhibiting three dimensional visuals from the display of the television. The screen has a top edge and a bottom edge being positioned parallel to each other. A pair of top clips is positioned on the top edge of the screen, wherein each of the top clips is configured for securing to the upper edge of the television. Furthermore, a pair of bottom clips is positioned on the bottom edge of the screen. Each of the bottom clips is configured for securing to the lower edge of the television. A pair of inputs is positioned on a right edge of the screen. A first input of the pair of inputs is configured for nesting a first insert of a connection cord, wherein the connection cord is configured for communicating the visuals from the display of the television to the screen. Additionally, a second input of the pair of inputs is configured for coupling to a power cord.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a three dimensional television attachment device according to an embodiment of the disclosure.

FIG. 2 is a rear view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is an alternate view of an embodiment of the disclosure.

FIG. 8 is an alternate view of an embodiment of the disclosure.

### DETAILED DESCRIPTION OF THE INVENTION

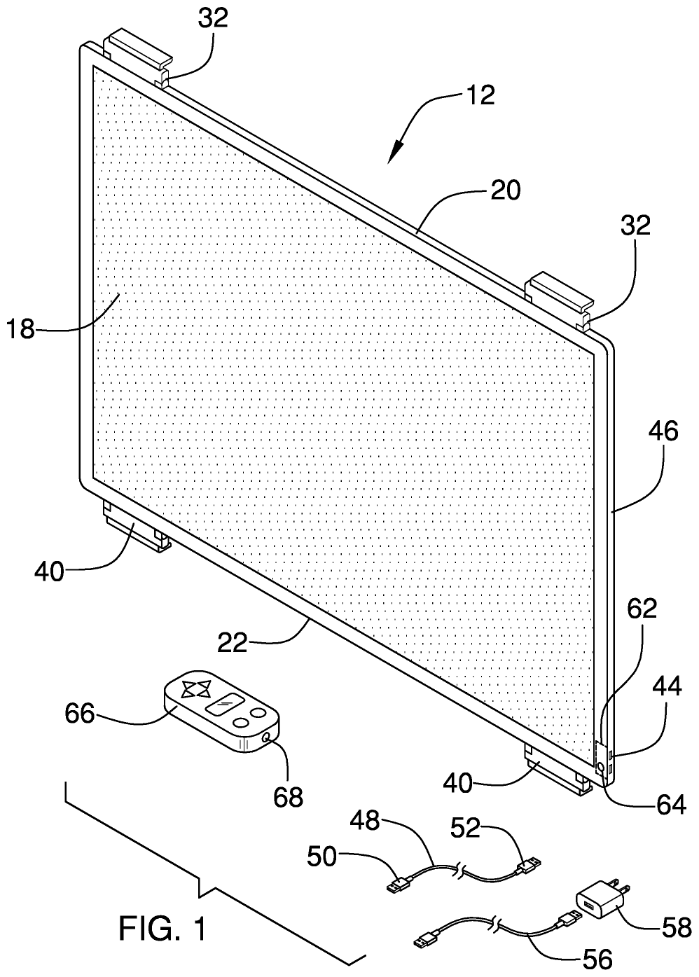

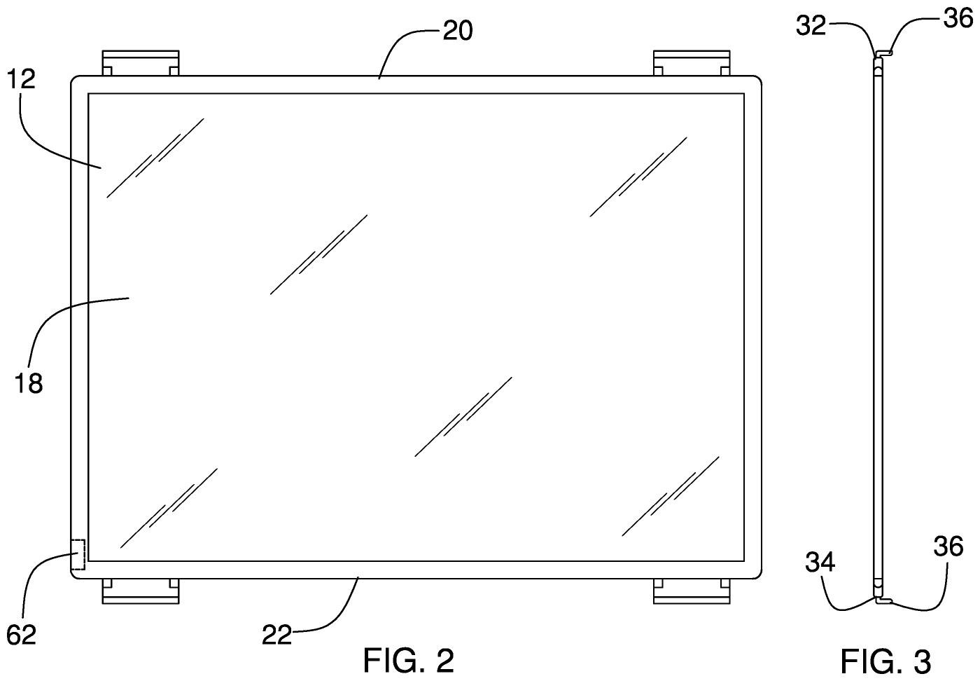

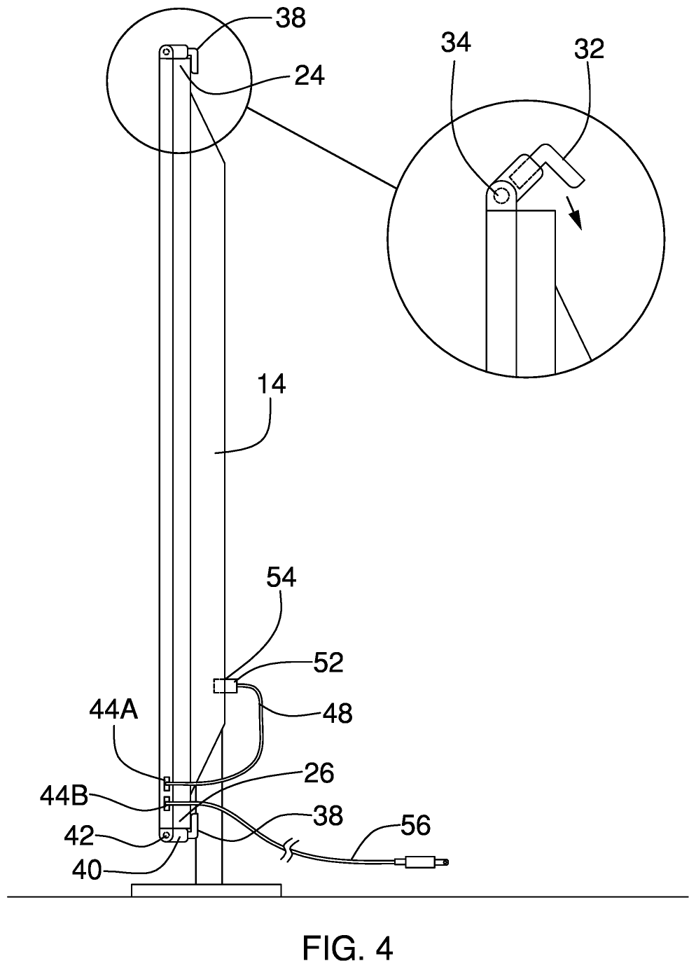

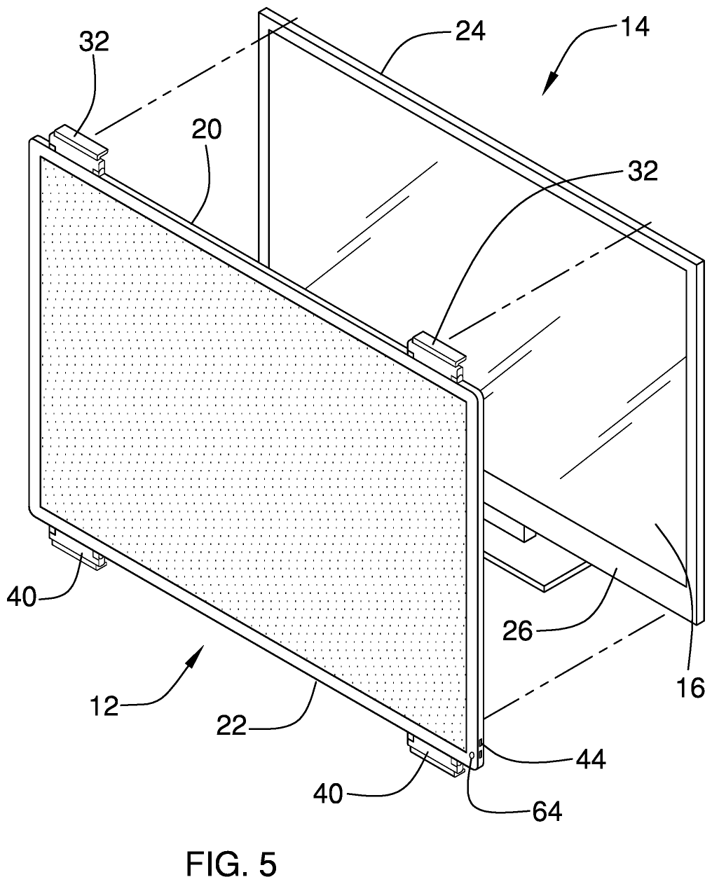

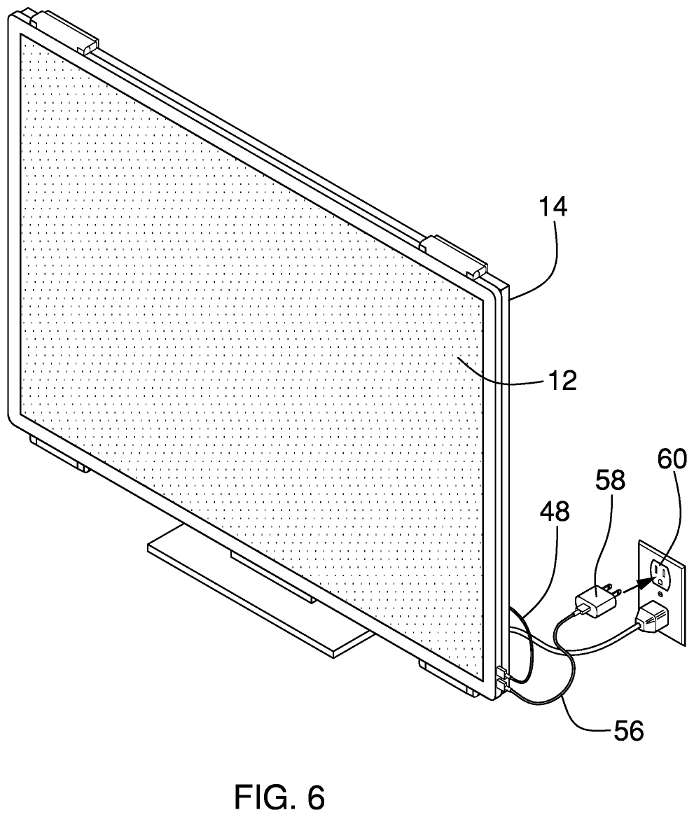

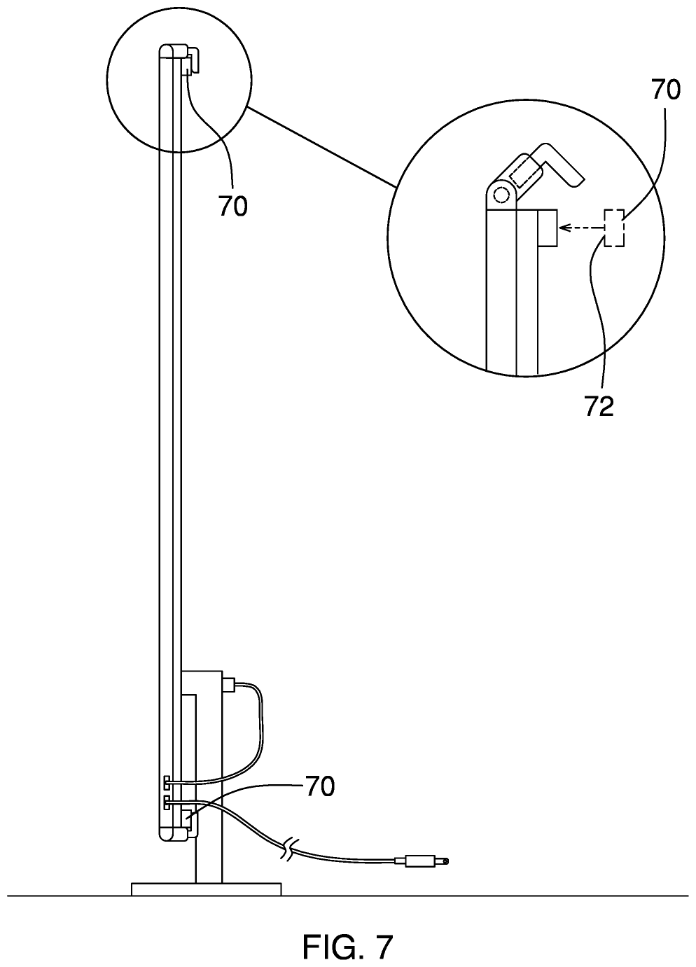

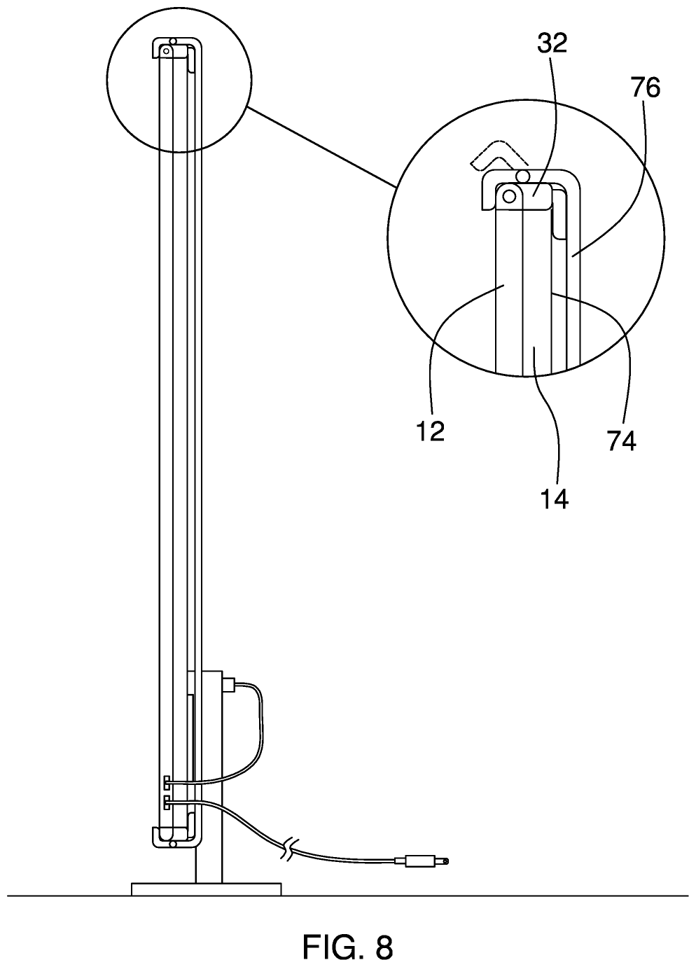

With reference now to the drawings, and in particular to FIGS. 1 through 8 thereof, a new television display attachment device embodying the principles and concepts of an embodiment of the disclosure and generally designated by the reference numeral 10 will be described.

As best illustrated in FIGS. 1 through 8, the three dimensional television attachment device 10 generally comprises a screen 12. The screen 12 is configured for abutting a display 16 of a television 14. The screen 12 has a liquid crystal display 18 being configured for use in a shutter lens technology. The shutter lens technology is configured for exhibiting three dimensional visuals from the display 16 of the television 14. Furthermore, the screen 12 has a top edge 20 and a bottom edge 22 being positioned parallel to each other. The top edge 20 is configured for being positioned flush relative to an upper edge 24 of the television 14, whereas the bottom edge 22 is configured for being positioned flush relative to a lower edge 26 of the television 14. Additionally, the top edge 20 has a pair of corners 28, and the bottom edge 22 has a pair of corners 30 as well.

A pair of top clips 32 is positioned on the top edge 20 of the screen 12. Each of the top clips 32 is positioned proximate to a respective one of each of the corners 28 of the top edge 20. Each of the top clips 32 has a hinge 34 being configured for positioning each of the top clips 32 in an open 36 and closed 38 position. In addition, the hinge 34 of each of the top clips 32 is spring loaded wherein each of the top clips 32 is biased towards a closed position 38. Each of the top clips 32 is configured for securing to the upper edge 24 of the television 14. Furthermore, a pair of bottom clips 40 is positioned on the bottom edge 22 of the screen 12. Each of the bottom clips 40 is positioned proximate to a respective one of each of the corners 30 of the bottom edge 22. Each of the bottom clips 40 has a hinge 42 configured for positioning each of the bottom clips 40 in an open 36 and closed 38 position, similar to each of the top clips 32. The hinge 42 of each of the bottom clips 40 is spring loaded such that each of the bottom clips 40 is biased towards a closed position 38. Each of the bottom clips 40 is configured for securing to the lower edge 22 of the television 14.

A pair of inputs 44 is positioned on a right edge 46 of the screen 12. Each of the inputs 44 is a universal serial bus port. A first input 44A of the pair of inputs 44 is configured for nesting a first insert 50 of a connection cord 48. In addition, a second insert 52 of the connection cord 48 is inserted into a universal serial bus port 54 of the television 14, wherein the connection cord 48 is configured for communicating the visuals from the display 16 of the television 14 to the screen 12. A second input 44B of the pair of inputs 44 is configured for coupling to a power cord 56. The power cord 56 has an outlet plug 58 and is configured for providing power to the screen 12 by inserting the outlet plug 58 into a power outlet 60.

A processor 62 is in electric communication with the pair of inputs 44 and is positioned proximate to the pair of inputs 44. The processor 62 is configured for actuating the screen 12 wherein exhibiting three dimensional visuals from the display 16 of the television 14. The processor 62 has a receiver 64 being positioned proximate to the bottom edge 22 of the screen 12. Furthermore, a remote 66 is in wireless communication with the processor 62 of the screen 12. The remote 66 is a control device configured for inputting actuation commands for the screen 12. The remote 66 has an output 68 being configured for sending infrared light waves to the receiver 64 of the processor 62 of the screen 12. The remote 66 is used to activate the screen 12 to begin emitting the three dimensional visuals.

Furthermore, a pair of blocks 70 is configured for assisting in securing the screen 12 to the television 14. Each of the blocks 70 has an adhesive surface 72 being configured for retaining to a back surface 74 of the television 14. The pair of blocks 70 is positioned adjacent to a respective one of the upper edge 24 of the television 14 and the lower edge 26 of the television 14. The pair of top clips 32 and the pair of bottom clips 40 are configured for securing to each of the blocks 70. The pair of blocks 70 is used for securing the screen 12 to a television 14 with a slimmer width compared to the width of each of the top clips 32 and each of the bottom clips 40. In addition to the pair of blocks 70, a pair of belts 76 is positioned upon the pair of top clips 32 and the pair of bottom clips 40 of the screen 12. The pair of belts 76 is configured for being positioned facing the back surface 74 of the television 14. Each of the belts 76 is secured to a respective one of each of the top clips 32 and a respective one of each of the bottom clips 40. The pair of belts 76 provides supplementary fastening of the screen 12 to the television 14.

In use, the screen 12 is positioned abutting the display 16 of the television 14. The top edge 20 of the screen 12 is positioned flush to the upper edge 24 of the television 14, wherein the bottom edge 22 of the screen 12 is positioned flush to the lower edge 26 of the television 14. The pair of top clips 32 and the pair of bottom clips 40 are in a closed position 38 to fasten to the television 14. The pair of blocks 70 can be used to help secure the pair of top clips 32 and the pair of bottom clips 40 to the television 14 if needed. Furthermore, the pair of belts 76 can be secured to a respective one of the pair of top clips 32 and the pair of bottom clips 40 for further fastening of the screen 12 to the television 14. The first input 44A of the pair of inputs 44 engages with the connection cord 46 to receive the visuals from the display 16 of the television 14. The second input 44B of the pair of inputs 44 engages with the power cord 54 to receive electric power for operation. The remote 66 in wireless communication with the processor 62 is used to actuate the screen 12 wherein emitting three dimensional visuals from the display 16 of the television 14 onto the screen 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A three dimensional television attachment device configured for enhancing the visual display from the television screen, the three dimensional television attachment device comprising:
a screen being configured for abutting a display of a television, said screen having a liquid crystal display, said liquid crystal display being configured for use in a shutter lens technology, said shutter lens technology being configured for exhibiting three dimensional visuals from said display of the television, said screen having a top edge and a bottom edge being positioned parallel to each other;
a pair of top clips being positioned on said top edge of said screen, each of said top clips being configured for securing to the upper edge of the television, each of said top clips having a hinge, said hinge of each of said top clips being configured for positioning each of said top clips in an open and closed position, said hinge of each of said top clips being spring loaded, each of said top clips being biased towards a closed position;
a pair of bottom clips being positioned on said bottom edge of said screen, each of said bottom clips being configured for securing to the lower edge of the television; and
a pair of inputs being positioned on a right edge of said screen, a first input of said pair of inputs being configured for nesting a first insert of a connection cord, said connection cord being configured for communicating said visuals from said display of the television to said screen, a second input of said pair of inputs being configured for coupling to a power cord.

2. The three dimensional television attachment device of claim 1, further comprising said top edge being configured for being positioned flush relative to an upper edge of the television, said bottom edge being configured for being positioned flush relative to a lower edge of the television.

3. The three dimensional television attachment device of claim 2, further comprising said top edge having a pair of corners, said bottom edge having a pair of corners.

4. The three dimensional television attachment device of claim 3, further comprising each of said top clips being positioned proximate to a respective one of each of said corners of said top edge.

5. (canceled)

6. The three dimensional television attachment device of claim 3, further comprising each of said bottom clips being positioned proximate to a respective one of each of said corners of said bottom edge.

7. The three dimensional television attachment device of claim 6, further comprising each of said bottom clips having a hinge, said hinge of each of said bottom clips being configured for positioning each of said bottom clips in an open and closed position, said hinge of each of said bottom clips being spring loaded, each of said bottom clips being biased towards a closed position.

8. The three dimensional television attachment device of claim 1, further comprising each of said inputs being a universal serial bus port.

9. The three dimensional television attachment device of claim 8, further comprising a second insert of said connection cord being inserted into a universal serial bus port of the television.

10. The three dimensional television attachment device of claim 9, further comprising said power cord being having a outlet plug, said power cord being configured for providing power to said screen by inserting said outlet plug into a power outlet.

11. The three dimensional television attachment device of claim 10, further comprising a processor being in electric communication with said pair of inputs, said processor being positioned proximate to said pair of inputs, said processor being configured for actuating said screen wherein exhibiting three dimensional visuals from said display of the television, said processor having a receiver, said receiver being positioned proximate to said bottom edge of said screen.

12. The three dimensional television attachment device of claim 11, further comprising a remote being in wireless communication with said processor of said screen, said remote being a control device configured for inputting actuation commands for said screen, said remote having an output, said output being configured for sending infrared light waves to said receiver of said processor of said screen.

13. The three dimensional television attachment device of claim 12, further comprising a pair of blocks being configured for assisting in securing said screen to the television, each of said blocks having an adhesive surface, said adhesive surface of each of said blocks being configured for retaining to a back surface of the television, said pair of blocks being positioned adjacent to a respective one of the upper edge of the television and the lower edge of the television, said pair of top clips and said pair of bottom clips being configured for securing to each of said blocks.

14. The three dimensional television attachment device of claim 13, further comprising a pair of belts being positioned upon said pair of top clips and said pair of bottom clips of said screen, said pair of belts being configured for being positioned facing the back surface of the television, each of said belts being secured to a respective one of each of said top clips and a respective one of each of said bottom clips.

15. A three dimensional television attachment device configured for enhancing the visual display from the television screen, the three dimensional television attachment device comprising:
a screen being configured for abutting a display of a television, said screen having a liquid crystal display, said liquid crystal display being configured for use in a shutter lens technology, said shutter lens technology being configured for exhibiting three dimensional visuals from said display of the television, said screen having a top edge and a bottom edge being positioned parallel to each other, said top edge being configured for being positioned flush relative to an upper edge of the television, said bottom edge being configured for being positioned flush relative to a lower edge of the television, said top edge having a pair of corners, said bottom edge having a pair of corners;
a pair of top clips being positioned on said top edge of said screen, each of said top clips being positioned proximate to a respective one of each of said corners of said top edge, each of said top clips having a hinge, said hinge of each of said top clips being configured for positioning each of said top clips in an open and closed position, said hinge of each of said top clips being spring loaded, each of said top clips being biased towards a closed position, each of said top clips being configured for securing to the upper edge of the television;
a pair of bottom clips being positioned on said bottom edge of said screen, each of said bottom clips being positioned proximate to a respective one of each of said corners of said bottom edge, each of said bottom clips having a hinge, said hinge of each of said bottom clips being configured for positioning each of said bottom clips in an open and closed position, said hinge of each of said bottom clips being spring loaded, each of said bottom clips being biased towards a closed position, each of said bottom clips being configured for securing to the lower edge of the television;
a pair of inputs being positioned on a right edge of said screen, each of said inputs being a universal serial bus port, a first input of said pair of inputs being configured for nesting a first insert of a connection cord, a second insert of said connection cord being inserted into a universal serial bus port of the television, said connection cord being configured for communicating said visuals from said display of the television to said screen, a second input of said pair of inputs being configured for coupling to a power cord, said power cord being having a outlet plug, said power cord being configured for providing power to said screen by inserting said outlet plug into a power outlet;
a processor being in electric communication with said pair of inputs, said processor being positioned proximate to said pair of inputs, said processor being configured for actuating said screen wherein exhibiting three dimensional visuals from said display of the television, said processor having a receiver, said receiver being positioned proximate to said bottom edge of said screen;
a remote being in wireless communication with said processor of said screen, said remote being a control device configured for inputting actuation commands tor said screen, said remote having an output, said output being configured for sending infrared light waves to said receiver of said processor of said screen;
a pair of blocks being configured for assisting in securing said screen to the television, each of said blocks having an adhesive surface, said adhesive surface of each of said blocks being configured for retaining to a back surface of the television, said pair of blocks being positioned adjacent to a respective one of the upper edge of the television and the lower edge of the television, said pair of top clips and said pair of bottom clips being configured for securing to each of said blocks; and
a pair of belts being positioned upon said pair of top clips and said pair of bottom clips of said screen, said pair of belts being configured for being positioned facing the back surface of the television, each of said belts being secured to a respective one of each of said top clips and a respective one of each of said bottom clips.
